(19) United States
(12) Patent Application Publication
(10) Pub. No.: US 2026/0074874 A1
(43) Pub. Date: Mar. 12, 2026

(54) Non-Collocated Carrier Aggregation

(71) Applicant: Apple Inc., Cupertino, CA (US)

(72) Inventors: Yuexia SONG, Beijing (CN); Fangli XU, Beijing (CN); Yang TANG, San Jose, CA (US); Dawei ZHANG, Saratoga, CA (US); Qiming LI, Beijing (CN); Jie CUI, San Jose, CA (US); Xiang CHEN, Palo Alto, CA (US); Rolando E BETTANCOURT ORTEGA, Munich (DE); Manasa RAGHAVAN, Sunnyvale, CA (US)

(21) Appl. No.: 19/102,182

(22) PCT Filed: Aug. 9, 2022
(86) PCT No.: PCT/CN2022/111216

§ 371 Date: Feb. 7, 2025

(51) Int. Cl. H04L 5/00; H04W 24/10

(52) U.S. Cl. CPC H04L 5/0098; H04W 24/10

(57) ABSTRACT

Embodiments of the present disclosure relate to non-collocated carrier aggregation (CA). According to embodiments of the present disclosure, a user equipment (UE) comprises a transceiver configured to communicate with a network; and a processor communicatively coupled to the transceiver and configured to perform operations. The operations comprise transmitting capability information about the UE to a base station, the capability information indicating that the UE supports a set of parameters for aggregation of non-collocated component carriers (CCs); receiving, from the base station, measurement object (MOs) which indicate the non-collocated CCs; transmitting, to the base station, measurements associated with the MOs; and receiving, from the base station, a signaling for activating or deactivating the non-collocated CCs.

### TECHNICAL FIELD

Embodiments of the present disclosure generally relate to the field of telecommunications, and in particular, to non-collocated carrier aggregation (CA).

### BACKGROUND

Intra-band co-located CA with transmission (Tx) antenna collocation has been well defined in Third Generation Partnership Project (3GPP) specifications. However, Tx antenna collocation is sometimes cost-inefficient or infeasible due to the operator spectrum situation. For example, the spectrum allocation is in a phased manner in the frequency range of 3300˜4200 MHz. There is no room to collocate the later launched antennas of a base station (BS) in a collocated manner with early launched antennas. In addition, different co-existence requirements apply for different spectrum blocks

### SUMMARY

In general, example embodiments of the present disclosure provide a solution for non-collocated CA.

In a first aspect, there is provided a UE. The UE comprises a transceiver and a processor. The transceiver is configured to communicate with a network. The processor is communicatively coupled to the transceiver and configured to perform operations comprising: transmitting capability information about the UE to a base station, the capability information indicating that the UE supports a set of parameters for aggregation of non-collocated component carriers (CCs); receiving, from the base station, measurement object (MOs) which indicate the non-collocated CCs; transmitting, to the base station, measurements associated with the MOs; and receiving, from the base station, a signaling for activating or deactivating the non-collocated CCs.

In a second aspect, there is provided a BS. The BS comprises a transceiver and a processor. The transceiver is configured to communicate with a network. The processor is communicatively coupled to the transceiver and configured to perform operations comprising: receiving capability information about a UE from the UE, the capability information indicating that the UE supports a set of parameters for aggregation of non-collocated CCs; transmitting, to the UE, MOs which indicate the non-collocated CCs; receiving measurements associated with the MOs from the UE; and transmitting, based on the measurements, a signaling for activating or deactivating the non-collocated CCs to the UE.

In a third aspect, there is provided a baseband processor of a UE. The baseband processor is configured to perform operations comprising: transmitting capability information about the UE to a base station, the capability information indicating that the UE supports a set of parameters for aggregation of non-collocated CCs; receiving, from the base station, MOs which indicate the non-collocated CCs; transmitting, to the base station, measurements associated with the MOs; and receiving, from the base station, a signaling for activating or deactivating the non-collocated CCs.

In a fourth aspect, there is provided a baseband processor of a BS. The baseband processor is configured to perform operations comprising: receiving capability information about a UE from the UE, the capability information indicating that the UE supports a set of parameters for aggregation of non-collocated CCs; transmitting, to the UE, MOs which indicate the non-collocated CCs; receiving measurements associated with the MOs from the UE; and transmitting, based on the measurements, a signaling for activating or deactivating the non-collocated CCs to the UE.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an example communication network in which example embodiments of the present disclosure can be implemented;

FIG. 2 illustrates an example of non-collocated CA in accordance with some example embodiments of the present disclosure;

FIG. 3 illustrates a signaling chart illustrating a process for non-collocated CA in accordance with some example embodiments of the present disclosure;

FIG. 4 illustrates a flowchart illustrating an example method implemented at a UE for mobility in accordance with some example embodiments of the present disclosure;

FIG. 5 illustrates a flowchart illustrating an example method for mobility implemented at a BS in accordance with some example embodiments of the present disclosure; and

FIG. 6 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. For example, as used herein, the singular forms “a”, “an” and “the” are intended to include the plural forms as well, unless the context clearly indicates otherwise. The terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. Moreover, when a particular feature, structure, or characteristic is described in connection with some embodiments, it is submitted that it is within the knowledge of one skilled in the art to affect such feature, structure, or characteristic in connection with other embodiments whether or not explicitly described.

It is also to be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (4C), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

FIG. 1 shows an example communication network 100 in which embodiments of the present disclosure can be implemented. The network 100 comprises a UE 110, a base station 120 and Remote Radio Units (RRUs) 131, 132, 133, 134 and 135.

An operator may launch antennas for the base station 120 in different time. There may be no room at the base station 120 to collocate the later launched antennas in a collocated manner with early antennas. Thus, the operator may launch antennas at the RRUs 131, 132, 133, 134 and 135 in distributed or non-collocated manner with the antennas at the base station 120.

It is to be understood that the numbers of UEs, BS and RRUs are only for the purpose of illustration without suggesting any limitations to the present disclosure. The network 100 may include any suitable number of UEs, BS and RRUs adapted for implementing implementations of the present disclosure.

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (4C), the fourth generation (4G), 4.5G, the fifth generation (5G) communication protocols.

A Component carrier (CC) from the base station 120 may be aggregated with CC(s) from one or more of the RRUs 131, 132, 133, 134 and 135 to increase the bandwidth. Such aggregation of the CCs is also referred to as non-collocated CA. The CC from the base station 120 and the CC from one or more of the RRUs 131, 132, 133, 134 and 135 may belong to the same operating frequency band, such as 3300˜4200 MHz. In such a case, the aggregation of the CCs is also referred to as intra-band non-collocated CA.

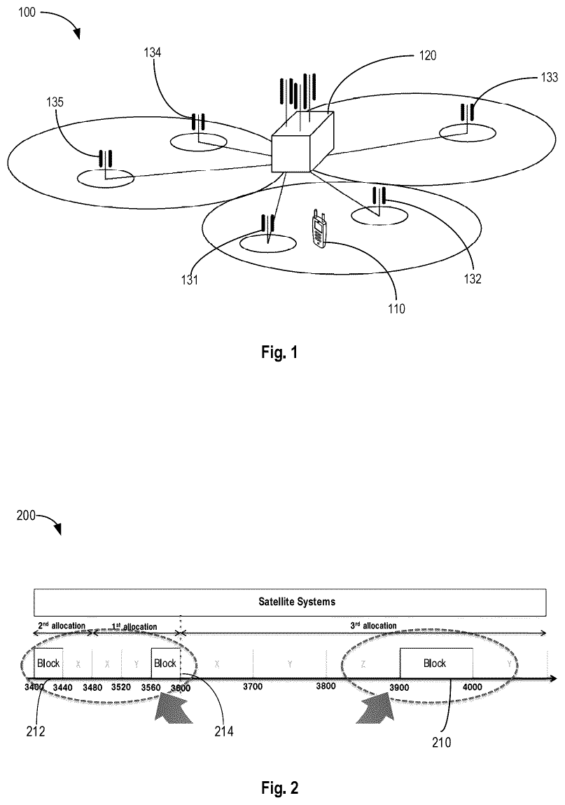

In some embodiments, the CC from the base station 120 and the CC(s) from one or more of the RRUs 131, 132, 133, 134 and 135 may belong to different spectrum blocks. This will be described with reference to FIG. 2.

FIG. 2 illustrates an example 200 of non-collocated CA in accordance with some example embodiments of the present disclosure. In the example 200, the CC from the base station 120 belongs to a spectrum block 210 in a frequency range of 3900˜4000 MHz. The CC from the RRU 131 belongs to one of spectrum blocks 212 and 214. The spectrum block 212 is in a frequency range of 3400˜3440 MHz and the spectrum block 214 is in a frequency range of 3560˜3600 MHz.

In the case of the non-collocated CA, power imbalance between the CCs supporting the CA may be as large as 25 dB. Larger arrival of time difference is also observed by the UE 110.

Currently, the intra-band collocated requirement is defined for UE only considering 6 dB power imbalance between the aggregated carriers, e.g. the minimum RF requirement in TS 38.101 and the demodulation performance in TS 38.101. 6 dB power imbalance means collocated BS antennas or very close in distance. There is still no requirement for support of intra-band non-collocated CA.

According to embodiments of the present disclosure, there is providing a solution for non-collocated CA. In this solution, UE transmits capability information about the UE to a BS. The capability information indicates that the UE supports a set of parameters for aggregation of non-collocated CCs. The BS activates or deactivates the non-collocated CCs based on the capability information. Thus, performance of the non-collocated CA may be improved.

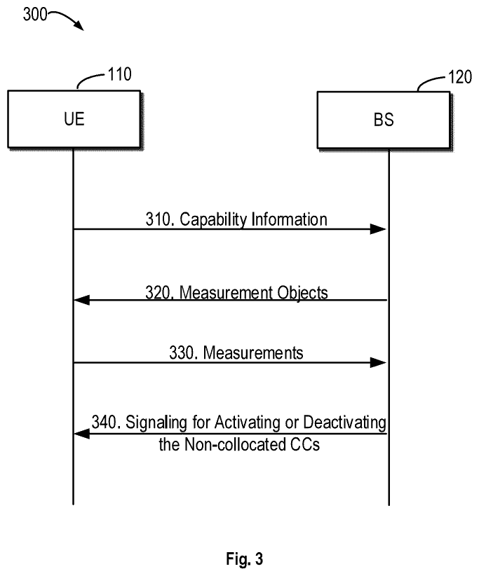

Reference is now made to FIG. 3, which shows a process 300 for non-collocated CA according to an embodiment of the present disclosure. For the purpose of discussion, the process 300 will be described with reference to FIG. 1. The process 300 may involve the UE 110 and the BS 120 as illustrated in FIG. 1. It would be appreciated that although the process 300 has been described in the communication network 100 of FIG. 1, this process may be likewise applied to other communication scenarios. It would also be appreciated that although the intra-band non-collocated CA will be discussed, a similar process can be applied for inter-band non-collocated CA.

As shown in FIG. 3, the UE 110 transmits 310 capability information about the UE 110 to the base station 120. The capability information indicates that the UE 110 supports a set of parameters for aggregation of non-collocated CCs.

The UE 110 receives 320, from the base station 120, measurement object (MOs) which indicate the non-collocated CCs.

In turn, the UE 110 may perform the measurement based on the MOs. Then, the UE 110 transmits 330 measurements associated with the MOs to the base station 120.

Upon receiving the measurements from the UE 110, the base station 120 transmits 340, based on the measurements, a signaling for activating or deactivating the non-collocated CCs to the UE 110. Accordingly, the UE 110 receives, from the base station 120, the signaling for activating or deactivating the non-collocated CCs.

With the process 300, the BS 120 may schedule the UE 110 based on the capability information which indicates that the UE 110 supports the set of parameters for aggregation of non-collocated CCs.

In some embodiments, the set of parameters for aggregation of non-collocated CCs may comprise a first set of parameters for aggregation of the non-collocated CCs. The first set comprises a first threshold for power imbalance between the non-collocated CCs and a second threshold for maximum received time difference (MRTD) between the non-collocated CCs. In some embodiments, the first threshold for power imbalance may be equal to 6 dB and the second threshold for the MRTD may be equal to 3 μs.

Alternatively, in some embodiments, the set of parameters for aggregation of non-collocated CCs may comprise a second set of parameters for aggregation of the non-collocated CCs. The second set comprises a third threshold for the power imbalance and a fourth threshold for the MRTD. The third threshold is higher than the first threshold, and the fourth threshold is higher than the second threshold. In some embodiments, the third threshold for power imbalance may be equal to 25 dB and the fourth threshold for the MRTD may be equal to 33 μs.

In some embodiments, the first set of parameters for aggregation of non-collocated CCs may be associated with an existing minimum radio frequency (RF) requirement in TS 38.101 and an existing demodulation performance in TS 38.101.

In some embodiments, the second set of parameters for aggregation of non-collocated CCs may be associated with a new minimum RF requirement to be introduced in TS 38.101 so as to test reference sensitivity requirement in presence of a jammer of 25 dB higher than the wanted signal. Some reference sensitivity degradation should be allowed. In such embodiments, the UE 110 will use separate RF chain to receive the aggregated carriers.

In some embodiments, additionally or alternatively, the second set of parameters for aggregation of non-collocated CCs may be associated with a new demodulation performance to be introduced in TS 38.101 so as to verify power imbalance of 25 dB between wanted signal and the aggregated carrier on adjacent channel.

In some embodiments, a UE supporting the first set of parameters for aggregation of non-collocated CCs may be referred to as a Type 1 UE.

In some embodiments, a UE supporting the second set of parameters for aggregation of non-collocated CCs may be referred to as a Type 2 UE.

In some embodiments, the capability information may comprise a UE capability parameter “intraBandNonColocatedCADL-r18” which indicates that the UE 110 supports the first or second set of parameters for aggregation of non-collocated CCs. Table 1 shows a definition for the UE capability parameter “intraBandNonColocatedCADL-r18”.

TABLE 1

| | | | FDD − TDD | FR1 − FR2 |
|---|---|---|---|---|
| Definitions for parameters | Per | M | DIFF | DIFF |
| intraBandNonColocatedCADL-r18 | BC | No | N/A | FR1 only |
| Indicates the UE supports FDD-FDD or TDD-TDD | | | | |
| intra/inter-band non-colocated CA operation with additional | | | | |
| REFSENS requirement in xx in 38.101-1, demodulation | | | | |
| requirement in xx in 38.101-4 and MRTD <33 us according to | | | | |
| 7.6.4 in 38.133. (i.e. Type 2 UE). | | | | |
| If the capability is not reported, the UE supports FDD-FDD or | | | | |
| TDD-TDD intra/inter-band operation with NR CA MRTD <3 us | | | | |
| according to 7.6.4 in 38.133 and intra-band minimum | | | | |
| RF/demodulation requirements in 38.101-1/-4 (i.e. Type 1 UE). | | | | |

In Table 1, “Per” indicates the level the associated parameter is included, and “BC” indicates it is signalled per band combination.

As shown in Table 1, in some embodiments, if absence of the UE capability parameter “intraBandNonColocatedCADL-r18” from the capability information may indicate that the UE 110 supports the first set of parameters for aggregation of non-collocated CCs.

In some embodiments, the MOs may indicate a serving cell and at least one candidate secondary cell associated with the non-collocated CCs.

In some embodiments, it is also essential to increase the opportunities for Type 1 UE to be scheduled by the base station 120 with the assistance of additional information report, such as reference signal received power (RSRP). Currently, the RSRP is reported separately for the serving cell and target cell. If the base station 120 would like to use this information for scheduling and activation or deactivation of a CC associated with a secondary cell (sCell), more frequency report is needed and hence there is more signaling overhead burden.

In order to reduce the signaling overhead, the measurements may comprise: a first reference signal received power (RSRP) of a strongest cell among the serving cell and the at least one candidate secondary cell, and an indication of an RSRP difference between the first RSRP and a second RSRP. The second RSRP is for a cell among the serving cell and the at least one candidate secondary cell. The cell is different from the strongest cell. In other words, the UE 110 may report the RSRP of the strongest cell and the RSRP difference between the RSRP of the strongest cell and an RSRP of other cell.

In some embodiments, a granularity for the RSRP difference and a range of the RSRP difference are predefined.

In some embodiments, the granularity for the RSRP difference may be 1 dB and the range of the RSRP difference may be 0 dB-30 dB.

Table 2 shows examples of the RSRP difference reporting. In Table 2, the RSRP difference is also referred to as differential RSRP.

TABLE 2

| Reported value | Measured quantity value | Unit |
|---|---|---|
| DIFFRSRP_0 | −30 ≥ ΔRSRP | dB |
| DIFFRSRP_1 | −29 ≥ ΔRSRP > −30 | dB |
| DIFFRSRP_2 | −28 ≥ ΔRSRP > −29 | dB |
| DIFFRSRP_3 | −27 ≥ ΔRSRP > −28 | dB |
| DIFFRSRP_4 | −26 ≥ ΔRSRP > −27 | dB |
| DIFFRSRP_5 | −25 ≥ ΔRSRP > −26 | dB |
| DIFFRSRP_6 | −24 ≥ ΔRSRP > −25 | dB |
| . . . | . . . | . . . |
| DIFFRSRP_25 | −5 ≥ ΔRSRP > −6 | dB |
| DIFFRSRP_26 | −4 ≥ ΔRSRP > −5 | dB |
| DIFFRSRP_27 | −3 ≥ ΔRSRP > −4 | dB |
| DIFFRSRP_28 | −2 ≥ ΔRSRP > −3 | dB |
| DIFFRSRP_29 | −1 ≥ ΔRSRP > −2 | dB |
| DIFFRSRP_30 | 0 ≥ ΔRSRP > −1 | dB |

In some embodiments, the measurements further comprise an SFTD between the serving cell and one of the at least one candidate secondary cell.

In some embodiments, if the capability information indicating that the UE 110 supports the first set of parameters, the RSRP difference is below a fifth threshold for the power imbalance and the SFTD is below a sixth threshold for the MRTD, the BS 120 may transmit a first signaling for activating the non-collocated CCs to the UE 110.

In some embodiments, the fifth threshold is equal to or greater than the first threshold for the power imbalance and less than the third threshold for the power imbalance. For example, the fifth threshold may be equal to 6 dB or slightly larger than 6 dB.

In some embodiments, the sixth threshold is equal to or greater than the second threshold for the MRTD and less than the fourth threshold for the MRTD. For example, the sixth threshold may be equal to 3 μs or slightly larger than 3 μs.

In some embodiments, if the capability information indicating whether the UE 110 supports the second set of parameters, and the RSRP difference is above the first threshold for power imbalance and below the third threshold for the power imbalance, or the SFTD is above the second threshold for MRTD and below the fourth threshold for the MRTD, the BS 120 may transmit a first signaling for activating the non-collocated CCs to the UE 110.

In some embodiments, in order to further reduce the signaling overhead, the measurements may not comprise the RSRP difference and the SFTD. Instead, the measurements may comprise a first flag. The first flag indicates that the RSRP difference is below the fifth threshold for the power imbalance and the SFTD is below the sixth threshold for the MRTD. The fifth threshold is equal to or greater than the first threshold. The sixth threshold for the MRTD is equal to or greater than the second threshold for the MRTD. Alternatively, the measurements may comprise a second flag. The second flag indicates that the RSRP difference is above the fifth threshold for the power imbalance or the SFTD is above the sixth threshold for the MRTD.

In such embodiments, if the BS 120 determines that the measurements comprise the first flag, the BS 120 may transmit a first signaling for activating the non-collocated CCs to the UE 110. If the BS 120 determines that the measurements comprise the second flag, the BS 120 may transmit a second signaling for deactivating the non-collocated CCs to the UE 110.

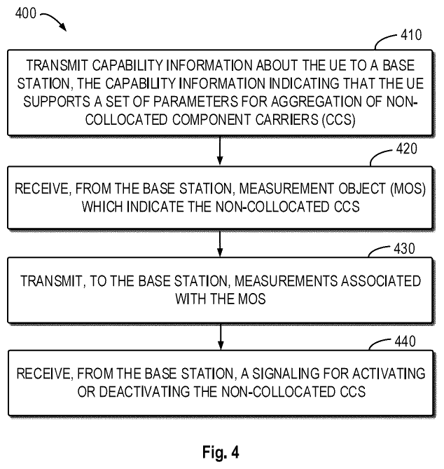

FIG. 4 illustrates a flowchart illustrating an example method 400 implemented at a UE for mobility in accordance with some example embodiments of the present disclosure. For the purpose of discussion, the method 400 will be described from the perspective of the UE 110 with reference to FIG. 1.

At block 410, the UE 110 transmits capability information about the UE to a base station, the capability information indicating that the UE supports a set of parameters for aggregation of non-collocated component carriers (CCs).

At block 420, the UE 110 receives, from the base station, measurement object (MOs) which indicate the non-collocated CCs.

At block 430, the UE 110 transmits, to the base station, measurements associated with the MOs.

At block 440, the UE 110 receives, from the base station, a signaling for activating or deactivating the non-collocated CCs.

In some embodiments, the set of parameters for aggregation of non-collocated CCs comprises: a first set of parameters for aggregation of the non-collocated CCs, the first set comprising a first threshold for power imbalance between the non-collocated CCs and a second threshold for maximum receiving time difference (MRTD) between the non-collocated CCs, or a second set of parameters for aggregation of the non-collocated CCs, the second set comprising a third threshold for the power imbalance and a fourth threshold for the MRTD, the third threshold being higher than the first threshold, and the fourth threshold being higher than the second threshold.

In some embodiments, the MOs indicate a serving cell and at least one candidate secondary cell associated with the non-collocated CCs.

In some embodiments, the measurements comprise: a first reference signal received power (RSRP) of a strongest cell among the serving cell and the at least one candidate secondary cell, and an indication of an RSRP difference between the first RSRP and a second RSRP, the second RSRP being for a cell among the serving cell and the at least one candidate secondary cell, the cell being different from the strongest cell.

In some embodiments, the measurements further comprise a system frame number (SFN) and frame timing difference (SFTD) between the serving cell and one of the at least one candidate secondary cell.

In some embodiments, a granularity for the RSRP difference and a range of the RSRP difference are predefined.

In some embodiments, the measurements comprise one of the following: a first flag indicating that the RSRP difference is below a fifth threshold for the power imbalance and the SFTD is below a sixth threshold for the MRTD, the fifth threshold being equal to or greater than the first threshold, the sixth threshold for the MRTD being equal to or greater than the second threshold for the MRTD, or a second flag indicating that the RSRP difference is above the fifth threshold for the power imbalance or the SFTD is above the sixth threshold for the MRTD.

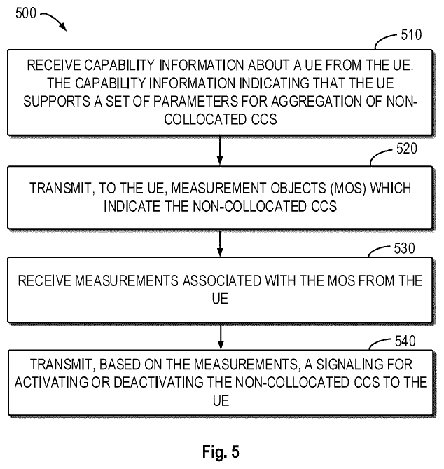

FIG. 5 illustrates a flowchart illustrating an example method 500 for mobility implemented at a BS in accordance with some example embodiments of the present disclosure. For the purpose of discussion, the method 500 will be described from the perspective of the BS 120 with reference to FIG. 1.

At block 510, the BS 120 receives capability information about a user equipment (UE) from the UE, the capability information indicating that the UE supports a set of parameters for aggregation of non-collocated CCs.

At block 520, the BS 120 transmits, to the UE, measurement objects (MOs) which indicate the non-collocated CCs.

At block 530, the BS 120 receives measurements associated with the MOs from the UE.

At block 540, the BS 120 transmits, based on the measurements, a signaling for activating or deactivating the non-collocated CCs to the UE.

In some embodiments, the set of parameters for aggregation of non-collocated CCs comprises: a first set of parameters for aggregation of the non-collocated CCs, the first set comprising a first threshold for power imbalance between the non-collocated CCs and a second threshold for maximum receiving time difference (MRTD) between the non-collocated CCs, or a second set of parameters for aggregation of the non-collocated CCs, the second set comprising a third threshold for the power imbalance and a fourth threshold for the MRTD, the third threshold being higher than the first threshold, and the fourth threshold being higher than the second threshold.

In some embodiments, the MOs indicate a serving cell and at least one candidate secondary cell associated with the non-collocated CCs.

In some embodiments, the measurements comprise: a first reference signal received power (RSRP) of a strongest cell among the serving cell and the at least one candidate secondary cell, and an indication of an RSRP difference between the first RSRP and a second RSRP, the second RSRP being for a cell among the serving cell and the at least one candidate secondary cell, the cell being different from the strongest cell.

In some embodiments, the measurements further comprise a system frame number (SFN) and frame timing difference (SFTD) between the serving cell and one of the at least one candidate secondary cell.

In some embodiments, a granularity for the RSRP difference and a range of the RSRP difference are predefined.

In some embodiments, transmitting the signaling for activating or deactivating the non-collocated CCs comprises: in accordance with a determination that the capability information indicating that the UE supports the first set of parameters, the RSRP difference is below a fifth threshold for the power imbalance and the SFTD is below a sixth threshold for the MRTD, transmitting a first signaling for activating the non-collocated CCs, the fifth threshold being equal to or greater than the first threshold for the power imbalance and less than the third threshold for the power imbalance, the sixth threshold being equal to or greater than the second threshold for the MRTD and less than the fourth threshold for the MRTD.

In some embodiments, transmitting the signaling for activating or deactivating the non-collocated CCs comprises: in accordance with a determination that the capability information indicating whether the UE supports the second set of parameters, and the RSRP difference is above the first threshold for power imbalance and below the third threshold for the power imbalance, or the SFTD is above the second threshold for MRTD and below the fourth threshold for the MRTD, transmitting a first signaling for activating the non-collocated CCs.

In some embodiments, the measurements comprise one of the following: a first flag indicating that the RSRP difference is below a fifth threshold for the power imbalance and the SFTD is below a sixth threshold for the MRTD, the fifth threshold being equal to or greater than the first threshold for the power imbalance and less than the third threshold for the power imbalance, the sixth threshold being equal to or greater than the second threshold for the MRTD and less than the fourth threshold for the MRTD, or a second flag indicating that the RSRP difference is above the fifth threshold for the power imbalance or the SFTD is above the sixth threshold for the MRTD.

In some embodiments, transmitting the signaling for activating or deactivating the non-collocated CCs comprises: in accordance with a determination that the measurements comprises the first flag, transmitting a first signaling for activating the non-collocated CCs; and in accordance with a determination that the measurements comprises the second flag, transmitting a second signaling for deactivating the non-collocated CCs.

The embodiments described with reference to FIG. 3 are also applied to the methods 400 and 500. Details of the embodiments are omitted for brevity.

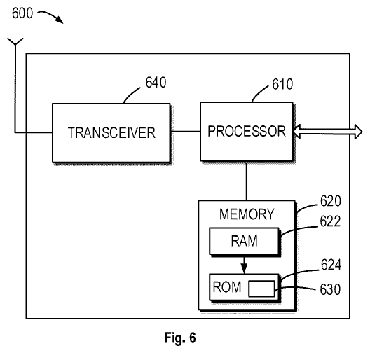

FIG. 6 is a simplified block diagram of a device 600 that is suitable for implementing embodiments of the present disclosure. For example, the UE 110 or the BS 120 can be implemented by the device 600. As shown, the device 600 includes a processor 610, a memory 620 coupled to the processor 610, and a transceiver 640 coupled to the processor 610.

The transceiver 640 is for bidirectional communications. The transceiver 640 is coupled to at least one antenna to facilitate communication. The transceiver 640 can comprise a transmitter circuitry (e.g., associated with one or more transmit chains) and/or a receiver circuitry (e.g., associated with one or more receive chains). The transmitter circuitry and receiver circuitry can employ common circuit elements, distinct circuit elements, or a combination thereof.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any method of the disclosure as discussed with reference to FIGS. 4 to 5. The embodiments of the present disclosure may also be implemented by hardware or by a combination of software and hardware.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 as described above with reference to FIG. 4 and/or the method 500 as described above with reference to FIG. 5.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A baseband processor of a user equipment (UE) configured to perform operations comprising:
transmitting capability information about the UE to a base station, the capability information indicating that the UE supports a set of parameters for aggregation of non-collocated component carriers (CCs);
receiving, from the base station, measurement objects (MOs) which indicate the non-collocated CCs;
transmitting, to the base station, measurements associated with the MOs; and
receiving, from the base station, a signaling for activating or deactivating the non-collocated CCs.

2. The baseband processor of the UE of claim 1, wherein the set of parameters for aggregation of non-collocated CCs comprises:
a first set of parameters for aggregation of the non-collocated CCs, the first set comprising a first threshold for power imbalance between the non-collocated CCs and a second threshold for maximum receiving time difference (MRTD) between the non-collocated CCs, or
a second set of parameters for aggregation of the non-collocated CCs, the second set comprising a third threshold for the power imbalance and a fourth threshold for the MRTD, the third threshold being higher than the first threshold, and the fourth threshold being higher than the second threshold.

3. The baseband processor of the UE of claim 2, wherein the MOs indicate a serving cell and at least one candidate secondary cell associated with the non-collocated CCs.

4. The baseband processor of the UE of claim 3, wherein the measurements comprise:
a first reference signal received power (RSRP) of a strongest cell among the serving cell and the at least one candidate secondary cell, and
an indication of an RSRP difference between the first RSRP and a second RSRP, the second RSRP being for a cell among the serving cell and the at least one candidate secondary cell, the cell being different from the strongest cell.

5. The baseband processor of the UE of claim 4, wherein the measurements further comprise a system frame number (SFN) and frame timing difference (SFTD) between the serving cell and one of the at least one candidate secondary cell.

6. The baseband processor of the UE of claim 4, wherein a granularity for the RSRP difference and a range of the RSRP difference are predefined.

7. The baseband processor of the UE of claim 5, wherein the measurements comprise one of the following:
a first flag indicating that the RSRP difference is below a fifth threshold for the power imbalance and the SFTD is below a sixth threshold for the MRTD, the fifth threshold being equal to or greater than the first threshold, the sixth threshold for the MRTD being equal to or greater than the second threshold for the MRTD, or
a second flag indicating that the RSRP difference is above the fifth threshold for the power imbalance or the SFTD is above the sixth threshold for the MRTD.

8. A base station, comprising:
a transceiver configured to communicate with a user equipment (UE); and
a processor communicatively coupled to the transceiver and configured to perform operations comprising:
receiving capability information about the UE from the UE, the capability information indicating that the UE supports a set of parameters for aggregation of non-collocated component carriers (CCs);
transmitting, to the UE, measurement objects (MOs) which indicate the non-collocated CCs;
receiving measurements associated with the MOs from the UE; and
transmitting, based on the measurements, a signaling for activating or deactivating the non-collocated CCs to the UE.

9. The base station of claim 8, wherein the set of parameters for aggregation of non-collocated CCs comprises:
a first set of parameters for aggregation of the non-collocated CCs, the first set comprising a first threshold for power imbalance between the non-collocated CCs and a second threshold for maximum receiving time difference (MRTD) between the non-collocated CCs, or
a second set of parameters for aggregation of the non-collocated CCs, the second set comprising a third threshold for the power imbalance and a fourth threshold for the MRTD, the third threshold being higher than the first threshold, and the fourth threshold being higher than the second threshold.

10. The base station of claim 9, wherein the MOs indicate a serving cell and at least one candidate secondary cell associated with the non-collocated CCs.

11. The base station of claim 10, wherein the measurements comprise:
a first reference signal received power (RSRP) of a strongest cell among the serving cell and the at least one candidate secondary cell, and
an indication of an RSRP difference between the first RSRP and a second RSRP, the second RSRP being for a cell among the serving cell and the at least one candidate secondary cell, the cell being different from the strongest cell.

12. The base station of claim 11, wherein the measurements further comprise a system frame number (SFN) and frame timing difference (SFTD) between the serving cell and one of the at least one candidate secondary cell.

13. The base station of claim 12, wherein a granularity for the RSRP difference and a range of the RSRP difference are predefined.

14. The base station of claim 12, wherein transmitting the signaling for activating or deactivating the non-collocated CCs comprises:
in accordance with a determination that the capability information indicating that the UE supports the first set of parameters, the RSRP difference is below a fifth threshold for the power imbalance and the SFTD is below a sixth threshold for the MRTD, transmitting a first signaling for activating the non-collocated CCs, the fifth threshold being equal to or greater than the first threshold for the power imbalance and less than the third threshold for the power imbalance, the sixth threshold being equal to or greater than the second threshold for the MRTD and less than the fourth threshold for the MRTD.

15. The base station of claim 12, wherein transmitting the signaling for activating or deactivating the non-collocated CCs comprises:
in accordance with a determination that the capability information indicating whether the UE supports the second set of parameters, and the RSRP difference is above the first threshold for power imbalance and below the third threshold for the power imbalance, or the SFTD is above the second threshold for MRTD and below the fourth threshold for the MRTD, transmitting a first signaling for activating the non-collocated CCs.

16. The base station of claim 12, wherein the measurements comprise one of the following:
a first flag indicating that the RSRP difference is below a fifth threshold for the power imbalance and the SFTD is below a sixth threshold for the MRTD, the fifth threshold being equal to or greater than the first threshold for the power imbalance and less than the third threshold for the power imbalance, the sixth threshold being equal to or greater than the second threshold for the MRTD and less than the fourth threshold for the MRTD, or
a second flag indicating that the RSRP difference is above the fifth threshold for the power imbalance or the SFTD is above the sixth threshold for the MRTD.

17. The base station of claim 16, wherein transmitting the signaling for activating or deactivating the non-collocated CCs comprises:
in accordance with a determination that the measurements comprises the first flag, transmitting a first signaling for activating the non-collocated CCs; and
in accordance with a determination that the measurements comprises the second flag, transmitting a second signaling for deactivating the non-collocated CCs.

18. A user equipment (UE), comprising:
a transceiver configured to communicate with a network; and
a processor communicatively coupled to the transceiver and configured to perform operations comprising:
transmitting capability information about the UE to a base station, the capability information indicating that the UE supports a set of parameters for aggregation of non-collocated component carriers (CCs);
receiving, from the base station, measurement objects (MOs) which indicate the non-collocated CCs;
transmitting, to the base station, measurements associated with the MOs; and
receiving, from the base station, a signaling for activating or deactivating the non-collocated CCs.

19. The UE of claim 18, wherein the set of parameters for aggregation of non-collocated CCs comprises:
a first set of parameters for aggregation of the non-collocated CCs, the first set comprising a first threshold for power imbalance between the non-collocated CCs and a second threshold for maximum receiving time difference (MRTD) between the non-collocated CCs, or
a second set of parameters for aggregation of the non-collocated CCs, the second set comprising a third threshold for the power imbalance and a fourth threshold for the MRTD, the third threshold being higher than the first threshold, and the fourth threshold being higher than the second threshold.

20. (canceled)
